(19) United States
(12) Patent Application Publication
(10) Pub. No.: US 2019/0006652 A1
(43) Pub. Date: Jan. 3, 2019

(54) BATTERY MODULE

(71) Applicant: LG ELECTRONICS INC., Seoul (KR)

(72) Inventor: Kwangmo KIM, Seoul (KR)

(21) Appl. No.: 16/018,916

(22) Filed: Jun. 26, 2018

(30) Foreign Application Priority Data
Jul. 3, 2017 (KR) 10-2017-0084375

(51) Int. Cl. H01M 2/20; H01M 2/30; B60L 11/18; B60K 1/04

(52) U.S. Cl. CPC H01M 2/206; H01M 2/305; B60K 2001/0438; B60K 1/04; H01M 2220/20; B60L 11/1879

(57) ABSTRACT

A battery module comprising at least one cell including an electrode terminal protruding along a prescribed direction, at least one bus bar having a bus bar contact surface, and at least one clip having a first member and a second member, the at least one clip clamping the electrode terminal with the bus bar contact surface when the first and second members are mated to prevent separation of contact between the electrode terminal and the bus bar contact surface.

### CROSS-REFERENCE TO RELATED APPLICATION

This application claims the priority benefit of Korean Patent Application No. 10-2017-0084375, filed on Jul. 3, 2017 in the Korean Intellectual Property Office, the disclosure of which is incorporated herein by reference in its entirety.

### BACKGROUND

### 1. Field

The present disclosure relates to a battery module, and more particularly to a battery module in which battery cells are detachably coupled to the battery module.

### 2. Background

Vehicles that are designed to generate driving force from engines using fossil fuels are problematic in that they cause air pollution. In order to overcome this problem, there is proposed a technology in which a secondary battery capable of being charged and discharged is used as the power source of a vehicle. In recent years, an electric vehicle (EV) capable of being operated using only a battery, a hybrid electric vehicle (HEV) capable of being operated using a combination of a battery and an existing engine have been developed and commercialized. As a secondary battery serving as a power source of an electric vehicle, a hybrid electric vehicle and the like, a nickel-metal-hydride battery, a lithium-ion battery or the like is used.

Since a high-output and high-capacity battery is required in order to be used as a power source of an electric vehicle, a hybrid electric vehicle or the like, a medium and large-sized battery module in which a large number of small-sized secondary batteries (unit batteries) are connected to each other in series and/or in parallel has been used. Laser welding, ultrasonic welding or the like is used in a process of connecting small-sized secondary batteries (unit batteries) in series and/or in parallel.

However, in the case of a battery module composed of a large number of small-sized secondary batteries which are connected to each other by using, for example, of welding, when a problem occurs in one among the large number of small-sized secondary batteries constituting the battery module, the entire battery module may require replacement with a new battery module because it is not possible to remove only the problematic small-sized secondary battery.

### BRIEF DESCRIPTION OF THE DRAWINGS

Embodiments will be described in detail with reference to the following drawings in which like reference numerals refer to like elements, and wherein:

FIG. 1 is a schematic view of a vehicle 1 including a battery module 100 according to a first embodiment of the present disclosure;

FIG. 2 is an exploded perspective view of a battery pack 10 including the battery module 100 according to the embodiment of the present disclosure;

FIG. 3 is a perspective view of the battery module 100 according to the embodiment of the present disclosure;

FIG. 4 is a perspective view of the battery module 100 shown in FIG. 3, in which a circuit board cover 115 is removed from the battery module 100;

FIG. 5 is an enlarged perspective view of a portion of the battery module 100 to which a clip 160 is coupled;

FIG. 6 is a perspective view of the clip 160 according to the embodiment;

FIG. 7 is a side elevation view of the clip 160 shown in FIG. 6;

FIG. 8 is a cross-sectional view taken along line A-A′ of FIG. 5;

FIG. 9 is a perspective view of a clip 160 according to a second embodiment of the present disclosure;

FIG. 10 is a side elevation view of the clip 160;

FIG. 11 is a perspective view of a clip 160 according to a third embodiment of the present disclosure;

FIG. 12 is a perspective view of a clip 160 according to a fourth embodiment of the present disclosure;

FIG. 13 illustrates a perspective view and a side elevation view of a clip 160 according to a fifth embodiment of the present disclosure;

FIG. 14 is a cross-sectional view taken along line B-B′ of FIG. 13.

FIG. 15 is an enlarged view of a portion of a battery module 200 to which a clip 260 is coupled, according to a sixth embodiment of the present disclosure;

FIG. 16 is a side elevation view of the clip 260 of FIG. 15;

FIG. 17 is a perspective view of a clip 360 according to a seventh embodiment of the present disclosure;

FIG. 18 is a perspective view of a clip 460 according to a eighth embodiment of the present disclosure; and

FIG. 19 is a cross-sectional view of an electrode terminal 433 and a bus bar 450 to which the clip 460 of FIG. 18 is coupled.

### DETAILED DESCRIPTION

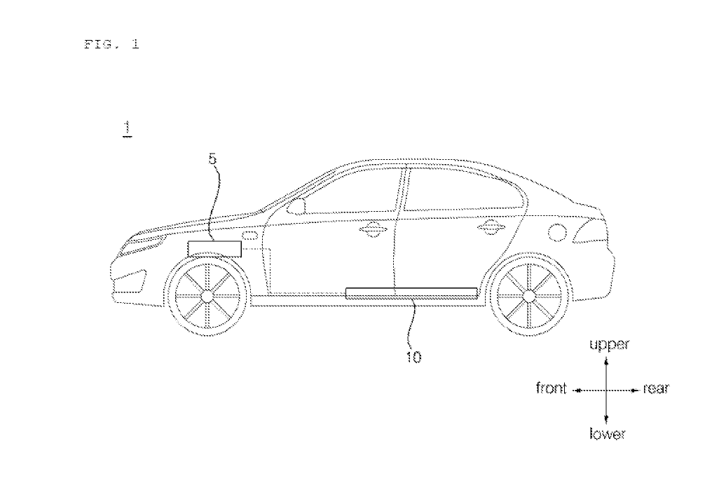

Referring to FIG. 1, a vehicle 1 according to an embodiment of the present disclosure may include a motor 5 for generating power required to drive the vehicle 1. The motor 5 is operated by electrical energy supplied from a battery pack 10, and is able to convert the electrical energy into kinetic energy.

The vehicle 1 may include the battery pack 10 for generating electrical energy. The battery pack 10 may be positioned at the center of the bottom of the vehicle body. However, other locations may be possible.

The battery pack 10 may be disposed between a front rotating shaft and a rear rotating shaft of the vehicle 1. The bottom of the vehicle body may be disposed at the lower side of the vehicle interior. The vehicle interior may be provided with an instrument panel, a center console box and a seat. The battery pack 10 may be disposed outside the vehicle interior, and the battery pack 10 may be disposed at a lower portion of the bottom of the vehicle body. The battery pack 10 may serve to replace a fuel tank of an internal-combustion vehicle. The battery pack 10 may be charged to increase energy stored or discharged to decrease energy stored in the battery pack 10. The battery pack 10 may generate heat during charging and discharging.

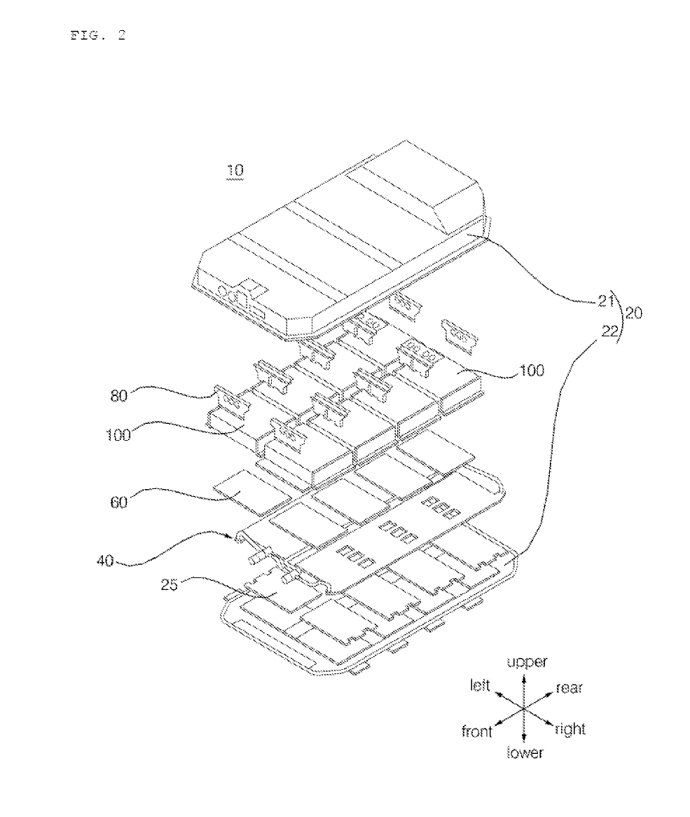

Referring to FIG. 2, the battery pack 10 may include a casing 20 defining the appearance of the battery pack 10. The casing 20 may include a cover 21 coupled to a tray 22 so as to cover the battery module 100. The casing 20 may include the tray 22 for supporting the load of the battery module 110. The casing 20 may include support panels 25, which are intended to increase rigidity of the tray 22 and to uniformly distribute the load of a heat sink 40 to the tray 22.

The battery pack 10 may include the heat sink 40 in which cooling water, cooling water with additive, or other coolant, absorbing heat energy generated from the battery module 100, flows. The heat sink 40 is made of a material having a high coefficient of heat transfer, and allows cooling water, cooling water with additive, or other coolant to flow therein.

The battery pack 10 may include thermal pads 60 for transferring heat energy from the battery module 100 to the heat sink 40. The thermal pads 60 may be thermal conductive pads. The thermal pads 60 may be made of a material having high heat conductivity. The battery pack 10 may also include brackets 80, which are disposed on the battery module 100 so as to support the cover 21.

The battery pack 100 may include the battery module 100 having battery cells for generating electrical energy. The battery pack 10 may include a plurality of battery modules 100 contained in the battery pack 10. The battery pack 10 may be configured such that the plurality of battery modules 100 are electrically connected to each other. The battery pack 10 may be configured such that the plurality of battery modules 100 are disposed on the same plane. The battery pack 10 may be configured such that the plurality of battery modules 100 are arranged one above the other.

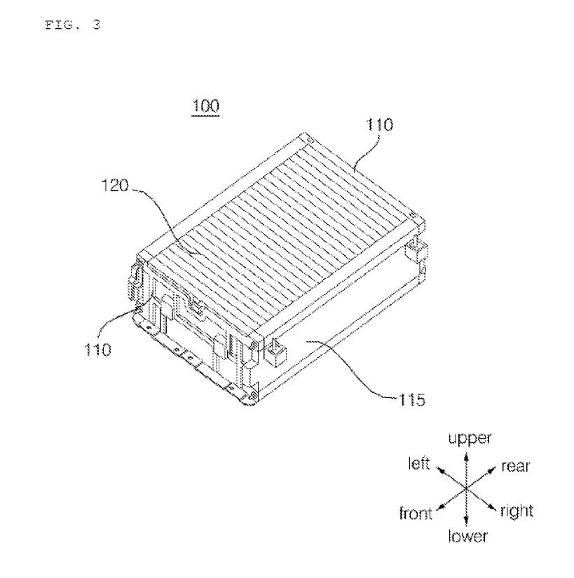

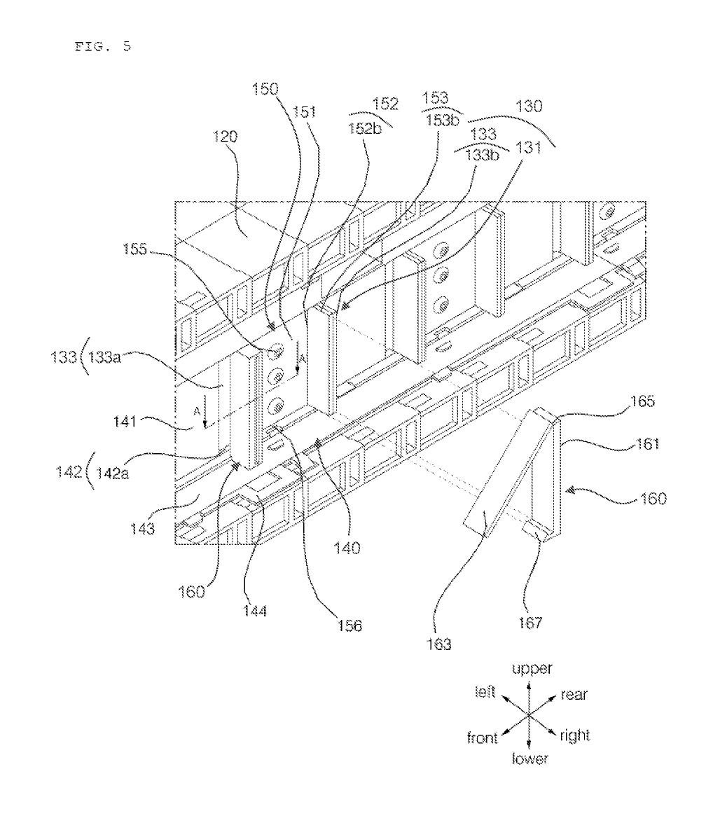

The battery module 100 according to an embodiment of the present disclosure will be described with reference to FIGS. 3 to 14. The battery module 100 may include battery cells 130, each of which includes electrode terminals 133 (including 133a, 133b, for example) which protrude at least in one direction. The battery cells 130 may include a plurality of battery cells which are stacked on each other. The battery module 100 may include a bus bar 150 for electrically connecting adjacent electrode terminals 133 of the battery cells 130 to each other. The bus bar 150 may be bent so as to define a bus bar contact surface parallel to the electrode terminal 133. The battery module 100 may include a clip 160 (see for example FIG. 5), which is coupled so as to bring the electrode terminal 133 into contact with or clamp with the bus bar 150. The clip 160 may include a first clip member 161 and a second clip member 163, which are mated. The clip clamps the electrode terminal with a bus bar contact surface when the first and second members of the clip are mated to prevent separation of or maintain contact between the electrode terminal and the bus bar contact surface.

Referring to FIG. 3, the battery module 100 may be configured to have a rectangular parallelepiped shape overall. A plurality of battery modules 100 may be disposed in the battery pack 10. The plurality of battery modules 100 may be disposed in the same plane in the battery pack 10. The plurality of battery modules 100 may be disposed one over the other in the battery pack 10.

The battery module 100 may include a cartridge cover 110 for covering at least one side of the stacked body in which a plurality of cell cartridges 120 are stacked. The cartridge cover 110 may cover opposite sides of the stacked body of the plurality of cell cartridges 120. Specifically, the cartridge cover 110 may cover opposite sides of the stacked body in the direction in which the plurality of cell cartridges 120 are stacked.

A pair of cartridge covers 110 may cover the opposite sides of the stacked body in the direction in which the plurality of cell cartridges 120 are stacked. The pair of cartridge covers 110 may cover opposite sides of the stacked body in the direction in which the plurality of cell cartridges 120 are stacked. The cartridge cover 110 may protect the cell cartridges 120 from external shocks. The cartridge cover 110 may also prevent foreign matter from entering the cell cartridges 120.

The cartridge cover 110 may be coupled to the cell cartridge 120. The cartridge cover 110 may be coupled to the cell cartridge 120 by using, for example, coupling elements. The cartridge cover 110 may be fastened to the cell cartridge 120 by using, for example, fastening elements or fasteners. The cartridge cover 110 may be configured to provide coupling force to the plurality of cell cartridges 120.

One of the cartridge cover 110 and the cell cartridge 120 may be provided with a protrusion while the other of the cartridge cover 110 and the cell cartridge 120 may be provided with a recess corresponding to the protrusion in order to increase the coupling force between the cartridge cover 110 and the cell cartridge 120.

Referring to FIG. 3, the battery module 100 may include a circuit board cover 115 for covering a circuit board 140 disposed on one surface of the battery module 100. The circuit board cover 115 may cover or may be provided on a surface of the battery module 100 that is not covered by the cartridge cover 110. The circuit board cover 115 may cover at least one side of a stacked body composed of the plurality of cell cartridges 120. The circuit board cover 115 may cover opposite sides of the stacked body composed of the plurality of stacked cell cartridges 120.

The circuit board cover 115 may protect the cell cartridges 120 from external shocks. The circuit board cover 115 may also prevent foreign substances from entering the cell cartridges 120.

The circuit board cover 115 may be coupled to the cell cartridges 120. The circuit board cover 115 may be coupled to the cell cartridges 120 by using, for example, a fastening member or fasteners. The circuit board cover 115 may be coupled to the cell cartridges 120 by using, for example, a coupling member.

One of the circuit board cover 115 and each of the cell cartridges 120 may be provided with a protrusion while the other of the circuit board cover 115 and the each of the cell cartridges 120 may be provided with a recess corresponding to the protrusion in order to couple the circuit board cover 115 to the corresponding one of the cell cartridges 120.

The circuit board cover 115 may provide the stacked cell cartridges 120 with coupling force. The circuit board cover 115 may be depressed so as to correspond to the protruding shape of the circuit board 140 so as to allow the circuit board 140 to be fitted or received partway into the circuit board cover 115 for coupling thereto.

The cell cartridge 120 may be configured to have a rectangular parallelepiped shape overall. The cell cartridge 120 may be made of a material having high thermal conductivity so as to efficiently transfer the heat generated from the battery cell 130 to the outside of the cell cartridge 120.

The cell cartridge 120 may have a space for accommodating the battery cell 130. The cell cartridge 120 may accommodate at least one battery cell 130 therein. In the embodiment, the cell cartridge 120 accommodates two battery cells 130 therein. However, the cell cartridge 120 may also accommodate three or more battery cells 130 therein.

The cell cartridge 120 may be provided with a thermal interface material (TIM) for improving thermal conductivity, in which the thermal interface material is provided on the surface of the cell cartridge 120 that the battery cell 130 contacts. The cell cartridge 120 may be configured to be open on at least one side thereof. In the embodiment, the cell cartridge 120 is open at opposite sides thereof. However, the cell cartridge 120 may be configured to be open only on one side thereof.

The cell cartridge 120 may be composed of a plurality of cell cartridges 120, which are stacked one on the other. The plurality of cell cartridges 120 may be configured to have shapes engaging with each other such that the plurality of cell cartridges 120 are stacked one on each other in an engaging manner.

The cell cartridge 120 may be disposed to be able to contact the cartridge cover 110. The cell cartridge 120 may be covered on at least one side thereof with the cartridge cover 110. The cell cartridge 120 may be covered on opposite sides thereof with the cartridge cover 110. The cell cartridge 120 may be covered and supported at opposite sides thereof with the cartridge cover 110 in the direction in which the plurality of cell cartridges 120 are stacked.

The battery cell 130 may generate electrical energy by virtue of a chemical reaction. The battery cell 130 may be of a pouch cell.

At least one battery cell 130 may be accommodated in the cell cartridge 120. In the embodiment, two battery cells 130 are accommodated in the cell cartridge 120. However, three or more battery cells 130 may also be accommodated in the cell cartridge 120.

The battery cell 130 may be composed of a plurality of battery cells, which are stacked one on the other. The plurality of battery cells 130 may be electrically connected to each other. The battery cell 130 may include a cell body 131, which generates electrical energy therein. The cell body 131 may be accommodated in the cell cartridge 120.

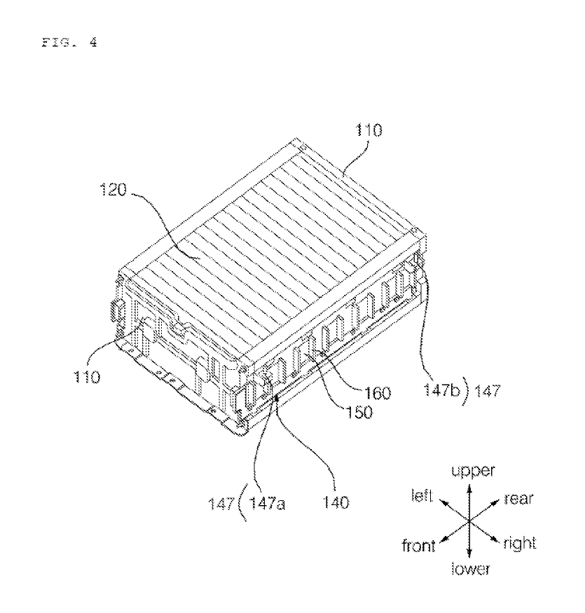

Referring to FIG. 4 and FIG. 5, the cell body 131 may include an electrode terminal 133 (including 133a, 133b, for example) for supplying electrical energy generated therein to the outside of the cell body 131. The cell body 131 may include the electrode terminal 133 protruding toward at least one side. The cell body 131 may include the electrode terminals 133 protruding to the left and/or right. In the embodiment, although the cell body 131 may include electrode terminals 133, which protrude to the left and right, the cell body 131 may alternatively include only one or more electrode terminals 133, which protrude in one direction.

The electrode terminal 133 may electrically connect adjacent battery cells 130 to each other. The electrode terminal 133 may transfer electrical energy in the battery cell 130 to the outside of the battery cell 130.

The electrode terminals 133 of different cell bodies 131 may be brought into contact with each other, and may thus be electrically connected to each other. The electrode terminals 133 of a plurality of adjacent cell bodies 131 are electrically connected to each other, and may be connected to each other in series in order to generate resultant power. The electrode terminals 133 of a plurality of adjacent cell bodies 131 are electrically connected to each other, and may be connected to each other in parallel so as to generate the resultant power.

The length that the electrode terminal 133 protrudes may be set such that the electrode terminal 133 contacts the bus bar 150 at a predetermined surface area thereof. The plurality of electrode terminals 133 may have the same length.

Referring to FIG. 5, the electrode terminal 133 may protrude through an electrode terminal passage hole 142 (142a, for example) formed in the circuit board 140. The electrode terminal 133 may protrude in a direction perpendicular to one surface of the circuit board 140 and may pass through the circuit board 140 so as to enable the circuit board 140 to be easily coupled to the battery module 100.

The electrode terminal 133 may pass through the electrode terminal passage hole 142 and may protrude a predetermined height outside the battery module 100. The length that the electrode terminal 133 protrudes outside the battery module 100 may be set to be equal to the length that the bus bar 150 protrudes outside the battery module 100 so as to realize close contact between the electrode terminal 133 and the bus bar 150.

The electrode terminal 133 may define an electrode terminal-bus bar contact surface of a predetermined surface area at which the electrode terminal 133 is in contact with the bus bar 150. The electrode terminal-bus bar contact surface may be configured to have a rectangular shape that is vertically elongate.

Referring to FIGS. 4 and 5, the circuit board 140 may include a plate-shaped circuit board body 141 having a rectangular plate shape overall. The circuit board 140 may include the electrode terminal passage hole 142 through which the electrode terminal 133 passes.

The electrode terminal passage hole 142 may be formed to be vertically elongate. The electrode terminal passage hole 142 may be composed of a plurality of electrode terminal passage holes 142, corresponding to respective ones of the plurality of electrode terminals 133. The plurality of electrode terminal passage holes 142 may be arranged on the circuit board 140 in the anteroposterior direction.

The electrode terminal passage hole 142 may serve to dispose the electrode terminal 133 inserted thereinto so as to space the same apart from the circuit board 140 such that the electrode terminal 133 easily passes through the circuit board 140 upon assembly.

The size of the electrode terminal passage hole 142 may be set or prescribed such that the electrode terminal 133 is spaced apart from the circuit board 140 by a predetermined distance so as to prevent the electrode terminal 133 from coming into contact with the circuit board 140. The arrangement thereby prevents energy loss.

The electrode terminal passage holes 142 may be arranged in the anteroposterior direction so as to allow the plurality of electrode terminals 133 to pass therethrough. The electrode terminal 133 may protrude outside the battery module 100 through the electrode terminal passage hole 142.

Referring to FIG. 5, the circuit board 140 may include a sub circuit board 143, which serves to electrically connect a plurality of bus bar terminals 156 to each other so as to measure the voltage of each of the battery cells 130. The sub circuit board 143 may be configured to have a rectangular plate shape overall.

The sub circuit board 143 may be disposed on the circuit board 140 so as to contact the bus bar terminals 156. The sub circuit board 143 may extend in an anteroposterior direction so as to contact the plurality of bus bar terminals 156.

A protrusion of the bus bar terminal 156 may be fitted into the sub circuit board 143 and coupled thereto. The sub circuit board 143 may be electrically connected to the bus bar terminal 156 so as to measure the voltage of each of the battery cells 130. The sub circuit board 143 may transmit information about the measured voltage of the battery cell to a controller (not shown).

Referring to FIG. 5, the circuit board 140 may be detachably coupled to the cell cartridge 120 by using, for example, a circuit board coupling portion 144. The circuit board 140 may have a coupling hole formed therein and the cell cartridge 120 may be provided with a coupling protrusion capable of being coupled or mated into the coupling hole so as to enable the circuit board 140 to be coupled to the cell cartridge 120.

Referring to FIG. 4, the circuit board 140 may include voltage terminals 147 (including 147a, 147b, for example) through which voltage is output from and input into the battery module 100. The voltage terminals 147 may be provided at front and rear sides of an upper portion of the circuit board 140.

Referring to FIG. 4 and FIG. 5, the bus bar 150 may include a bus bar body 151 having a rectangular plate shape overall. The bus bar body 151 may be configured to extend vertically.

The bus bar 150 may be disposed between a pair of electrode terminal passage holes 142, which are arranged at the circuit board 140 in the anteroposterior direction. The bus bar 150 may be coupled at one surface thereof to the circuit board 140 while being in contact with the circuit board 140. The bus bar 150 may be coupled to the circuit board 140 by using, for example, heat fusion.

The plurality of bus bars 150 may be arranged in series in the direction in which the plurality of battery cells 130 are stacked on each other so as to be electrically connected to respective ones of the battery cells 130. The bus bar 150 may be coupled to the circuit board 140 in a state of being in contact therewith.

The bus bar body 151 may be configured to have a rectangular plate shape. The bus bar body 151 may be coupled at one surface thereof to the circuit board 140 in the state of being in contact therewith. The bus bar body 151 may be coupled to the bus bar 150 by using, for example, heat fusion.

The length of the bus bar body 151 in the anteroposterior direction may be set to be equal to the distance between the electrode terminals 133 that protrude in one direction of the bus bar 150. The length of the bus bar body 151 in the anteroposterior direction may be set to be equal to the distance that the electrode terminals 133 are spaced apart from each other, and bus bar bent portions 152 (including 152a, 152b, for example) that are bent at ends of the bus bar body 151 and extend outward may be in contact with the electrode terminals 133.

The length of the bus bar body 151 in a vertical direction may be set to be equal to the length, in a vertical direction, of the electrode terminals 133 that protrude in one direction of the bus bar 150 such that the bus bar bent portion 152 that extends from the bus bar body 151 is brought into close contact with the electrode terminal 133.

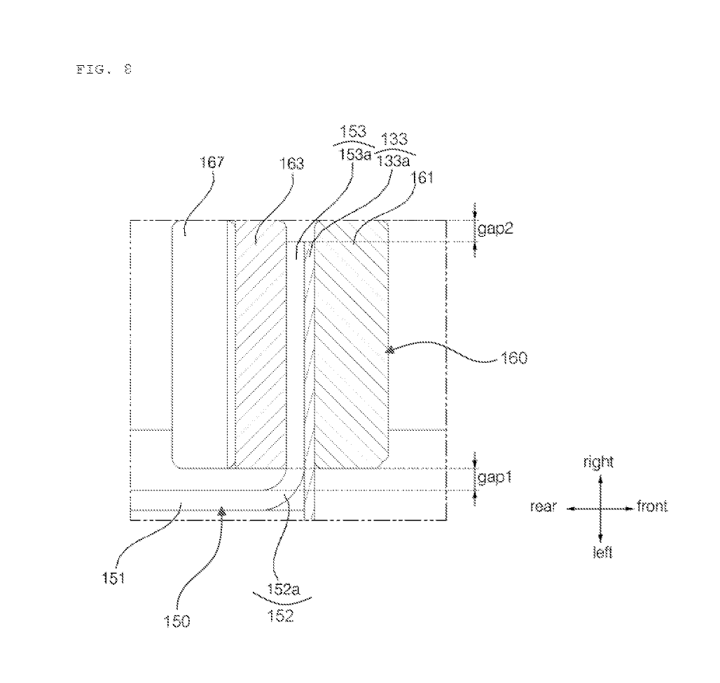

Referring to FIGS. 5 and 8, the bus bar 150 may include the bus bar bent portion 152 provided on at least one end of the bus bar body 151. The bus bar 150 may include the bus bar bent portions 152, which are formed at opposite ends of the bus bar body 151. The bus bar bent portions 152 may extend vertically, and the bus bar body 151 may be provided at front and rear ends thereof with respective bus bar legs 153 (including 153b, for example).

The bus bar bent portion 152 may be difficult to accurately bend at an angle of 90 degrees owing to the particular characteristics and limitations of the manufacturing process, and may be configured to have a round or curved shape having a predetermined curvature. As shown in FIG. 8 for example, the clip 160 may be disposed so as to be spaced apart from the bus bar bent portion 152 in order to prevent the clip 160 from being spaced apart from the bus bar 150 proximate where the bus bar 150 contacts an electrode terminal 133 and thus to prevent the occurrence of a loose connection between the clip 160 and the bus bar 150.

With reference to FIG. 8, for example, the clip 160 may be spaced apart from the bus bar body 151 by a distance corresponding to a gap 1 in order to prevent the occurrence of a loose connection owing to the curvature of the bus bar bent portion 152. The distance gap 1 may be set depending on the curvature of the bus bar bent portion 152.

Referring to FIGS. 5 and 8, the bus bar 150 may include the bus bar legs 153, which are bent at an end of the bus bar body 151 and extend therefrom. The bus bar 150 may include the bus bar leg 153 that is formed by bending at least one end of the bus bar body 151. The bus bar legs 153 may be formed by bending opposite ends of the bus bar body 151.

Each of the bus bar legs 153 may be configured to have a vertically elongate rectangular plate shape. The bus bar legs 153 may be provided at front and rear ends of the bus bar body 151.

The bus bar legs 153 may be configured to be perpendicular to one surface of the bus bar body 151. Each bus bar leg 153 may be configured such that the length that the bus bar leg 153 protrudes outside the battery module 100 is equal to the length that the electrode terminal 133 protrudes outside the battery module 100 so as to bring the bus bar leg 153 into close contact with the electrode terminal 133.

The bus bar leg 153 may define the electrode terminal-bus bar contact surface at which the bus bar leg 153 contacts the electrode terminal 133. The electrode terminal-bus bar contact surface may have a vertically elongate rectangular shape. The bus bar leg 153 may be parallel to the electrode terminal 133, which may enhance and/or improve contact efficiency there between.

Referring to FIG. 5, the bus bar 150 may include a bus bar coupler 155 for coupling the bus bar 150 to the circuit board 140. The bus bar coupler 155 may pass through the circuit board 140 and the bus bar 150 so as to couple the circuit board 140 and the bus bar 150 to each other.

The bus bar coupler 155 may be configured so as to couple the bus bar 150 and the circuit board 140 to each other by using, for example, heat fusion. The bus bar coupler 155 may include a plurality of bus bar couplers 155, which are arranged in the longitudinal direction of the bus bar 150, in order to increase the coupling force between the bus bar 150 and the circuit board 140.

Referring to FIG. 5, the bus bar 150 may include the bus bar terminal 156, which protrudes from an end thereof in one direction so as to contact the sub circuit board 146. The bus bar terminal 156 comes into contact with the sub circuit board 143 such that the bus bar 150 is electrically connected to the sub circuit board 143. The bus bar 156 may be provided at the end thereof with a protrusion that is fitted into and coupled to the hole formed in the sub circuit board 143 such that the bus bar 150 is steadily and electrically connected to the sub circuit board 143.

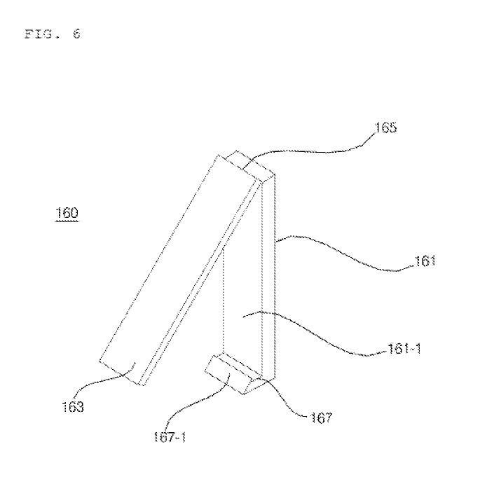

With reference to FIG. 6, for example, the clip 160 may be composed of members or legs, which are coupled or mated to each other so as to bring the electrode terminal 133 into contact with the bus bar 150. The clip 160 may include the first clip member or leg 161 and the second clip member or leg 163.

The clip 160 may surround opposite peripheral regions of the contact area between the electrode terminal 133 and the bus bar 150 in the longitudinal direction of the contact area so as to guide, maintain or ensure the contact relationship between the electrode terminal 133 and the bus bar 150. The clip 160 may be disposed to be spaced apart from the bent portion 152 of the bus bar 150. The clip 160 may be spaced apart from the bus bar body 151 by a distance gap1 (with reference to FIG. 8) in order to prevent the clip 160 from being spaced apart from the bus bar 150 proximate the electrode terminal-bus bar contact owing to the bus bar bent portion 152 and thus to prevent the occurrence of a loose connection there between.

The clip 160 may be made of a material that is somewhat elastic, and the clip members 161 and 163 may be coupled or mated to each other in a snap-fit manner. The clip 160 may be made of a plastic material so as to be bent and then restored upon snap-fit coupling.

The clip 160 may be configured to cover the contact area between the electrode terminal 133 and the bus bar 150 in the state in which the electrode terminal 133 is in contact with the bus bar 150. Referring to FIG. 8, the clip 160 may be configured to protrude further than the electrode terminal 133 and the bus bar 150 by a distance gap2 in order to efficiently protect the electrode terminal 133 and the bus bar 150 from shocks and contamination.

In the embodiment, the clip 160 is configured such that one surface of the first clip member 161 is in contact with the electrode terminal 133 and one surface of the second clip member 163 is in contact with the bus bar 150. Alternatively, it is possible to provide a configuration in which the first clip member 161 is in contact with the bus bar 150 and the second clip member 163 is in contact with the electrode terminal 133.

Referring to FIGS. 5 to 8, the clip 160 may be composed of a plurality of clip members 161 and 163, which are coupled to each other in a snap-fit manner. The first clip member 161 may be provided with a snap hook 167-1. The second clip member 163 may be provided with a structure that is engageable with the snap hook 167-1 so as to allow the first clip member 161 and the second clip member 163 to be coupled to each other in a snap-fit manner.

Referring to FIG. 6, the clip 160 may be provided at one end thereof with a snap protrusion 167. The snap protrusion 167 may be bent and extend at one end of the first clip member 161. The snap protrusion 167 may include the snap hook 167-1, which may be coupled to one end of the second clip member 163 in a snap-fit manner.

The length of the snap protrusion 167 may be set based on the thickness of the second clip member 163. The length of the snap protrusion 167 may be set based on the thicknesses of the electrode terminal 133 and the bus bar 150.

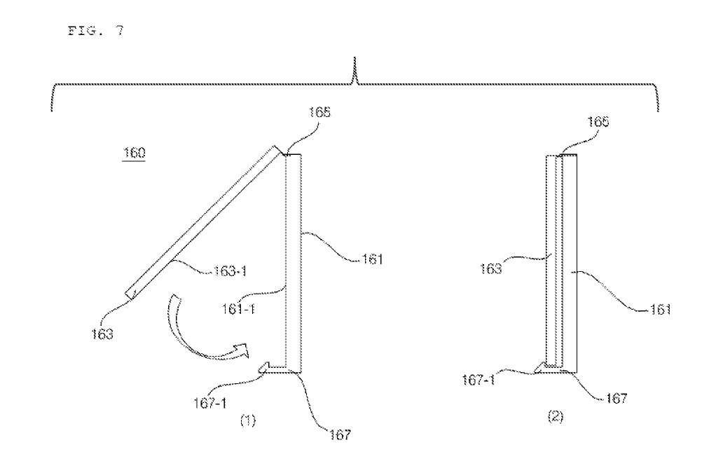

Referring to FIG. 7, the length of the snap protrusion 167 may be set such that the first clip member 161 and the second clip member 163 are coupled to each other in a snap-fit manner in a state in which the electrode terminal 133 and the bus bar 150 are disposed between the first clip member 161 and the second clip member 163. FIG. 7 shows the clip 160 open (1) and the clip 160 closed (2).

Referring to FIGS. 6 and 7, the snap hook 167-1 may be configured to protrude toward a first clip contact surface 161-1 from one end of the snap protrusion 167. The snap hook 167-1 may be configured to protrude upward from the one end of the snap protrusion 167.

The thickness of the snap protrusion 167 may be set in consideration of the elasticity thereof such that the snap protrusion 167 is bent upon coupling between the first clip member 161 and the second clip member 163 and upon release of the coupling. The snap protrusion 167 is bent downward and then restored by virtue of the elasticity thereof, thereby establishing a snap-fit coupling between the first clip member 161 and the second clip member 163, when the first clip member 161 and the second clip member 163 are coupled to each other.

The snap protrusion 167 is bent downward and then restored by elastic force to allow the release of the coupling between the first clip member 161 and the second clip member 163, when the first clip member 161 is separated from the second clip member 163. The clip 160 that is constructed as described above may provide advantages in that the first clip member 161 and the second clip member 163 are coupled to each other without a gap there between and in that it is convenient to perform coupling and separation between the first clip member 161 and the second clip member 163.

The first clip member 161 may come into contact with the electrode terminal 133 at the first clip contact surface 161-1, and may support the electrode terminal 133. The clip 160 may include a protrusion provided on at least one surface of the facing surfaces of the first clip member 161 and the second clip member 163. The protrusion according to an embodiment of the present disclosure may be composed of a plurality of protrusions, which protrude a predetermined height and are arranged in a matrix pattern.

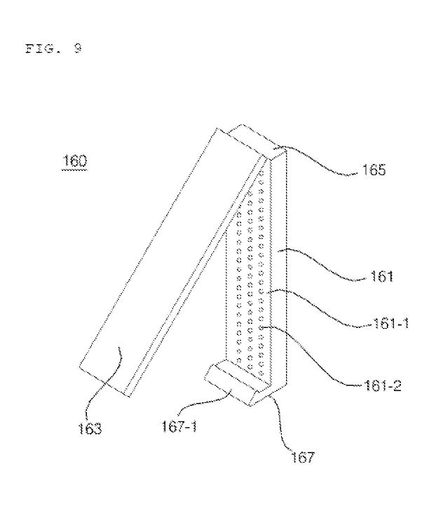

Referring to FIG. 9, the first clip member 161 may include a plurality of protrusions provided on the first clip contact surface 161-1, which may increase the coupling force between the electrode terminal 133 and the bus bar 150.

Since the first clip member 161 is provided on the first clip contact surface 161-1 with the plurality of protrusions, it may be possible to reduce the effects caused by manufacturing tolerance and to efficiently support the electrode terminal 133 even when the first clip contact surface 161-1 is uneven due to the manufacturing tolerance. The plurality of protrusions may be configured to have a hemisphere shape so as to stably support the bus bar 150 and/or electrode terminal 133. In the embodiment, although the plurality of protrusions are configured to have a hemisphere shape, it is possible for the protrusions to have other shapes.

The protrusion according to another embodiment of the present disclosure may be a linear protrusion, which extends in the longitudinal direction of the clip 160. The first clip member 161 may include the linear protrusion. The first clip member 161 may include the linear protrusion on the first clip contact surface 161-1 so as to increase the coupling force between the electrode terminal 133 and the bus bar 150.

Since the first clip member 161 includes the linear protrusion, it may be possible to reduce the effects caused by manufacturing tolerance and to efficiently support the electrode terminal 133 even when the first clip contact surface 161-1 is uneven due to manufacturing tolerance. The first clip member 161 may include a plurality of linear protrusions, which are disposed parallel to each other, which may efficiently support the electrode terminal 133.

The clip 160 may include an electrical conductor on one of the facing surfaces of the first and second clip members. The protrusion or protrusions may be disposed on the electrical conductor.

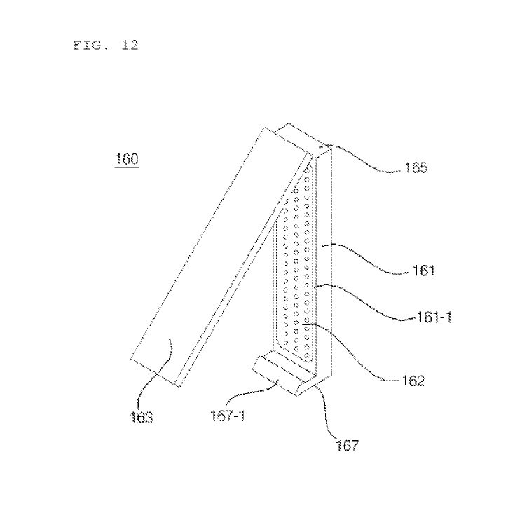

Referring to FIG. 12, the first clip member 161 may include a first clip conductor 162 provided on the first clip contact surface 161-1 so as to improve the electrical connectivity between the electrode terminal 133 and the bus bar 150. The first clip conductor 162 may be fitted partway into a recess formed in the first clip contact surface 161-1 and may thus be coupled thereto.

The first clip conductor 162 may be made of a material having higher electrical conductivity than that of the clip 160. The first clip conductor 162 may be made of a metal material. The first clip conductor 162 may include a protrusion provided on the face thereof that comes into contact with the electrode terminal 133. Referring to FIG. 12, the first clip conductor 162 according to an embodiment of the present disclosure includes a plurality of protrusions provided on the surface thereof that comes into contact with the electrode terminal 133, which may improve the electrical connectivity between the electrode terminal 133 and the bus bar 150.

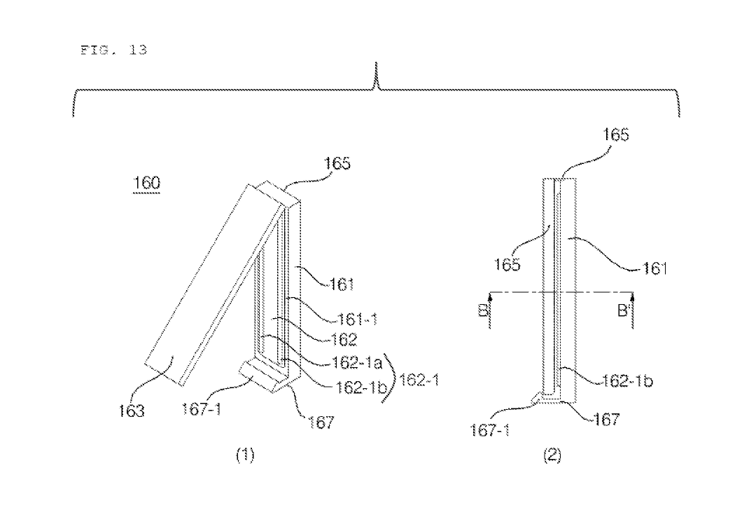

Referring to FIG. 13, a first clip conductor 162 according to another embodiment of the present disclosure includes a linear protrusion 162-1 (including 162-1a, 162-1b, for example) provided on the face thereof that comes into contact with the electrode terminal 133 so as to improve the electrical connectivity between the electrode terminal 133 and the bus bar 150. The first clip conductor 162 may include a plurality of linear protrusions 162-1, which are disposed parallel to each other, so as to efficiently support the electrode terminal 133.

Although the first clip member 161 according to the embodiment includes the linear protrusion 162-1 provided on the first clip conductor 162, it may be also possible to provide a configuration in which the linear protrusion 162-1 is directly disposed on the first clip contact surface 161-1 without providing the first clip conductor 162. As shown, FIG. 13 shows the clip 160 open (1) and the clip 160 closed (2).

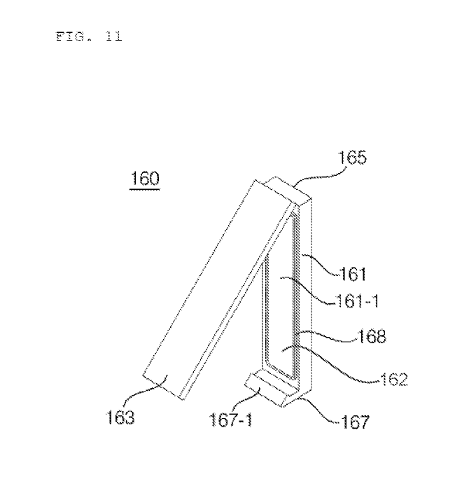

Referring to FIG. 11, the clip 160 may include a buffer portion or cushion 168, which is provided on at least one surface of the facing surfaces of the first clip member 161 and the second clip member 163. The first clip member 161 may include the buffer portion 168 provided on the first clip contact surface 161-1, which may improve the electrical connectivity between the electrode terminal 133 and the bus bar 150.

The first clip member 161 may include the buffer portion 168, which is provided along the peripheral region of the first clip contact surface 161-1, so as to efficiently support the electrode terminal 133. The first clip member 161 may include the buffer portion 168, which is provided between the first clip conductor 162 and the first clip contact surface 161-1.

The buffer portion 168 may protrude further than the first clip conductor 162 when the second clip member 163 is separated from the first clip member 161 so as to efficiently support the electrode terminal 133. The buffer portion 168 may be made of a material having a predetermined elasticity in addition to other materials. The buffer portion 168 may be a rubber packing.

The second clip member 163 may be configured to have a structure that is engaged with the snap hook 167-1 such that the first clip member 161 is coupled to the second clip member 163 in a snap-fit manner. The second clip member 163 may be coupled at one end thereof to the snap hook 167-1 in a snap-fit manner. The second clip member 163 may include a snap groove formed in the end thereof that is coupled to the snap hook 167-1 so as to guide the snap hook 167-1 to the coupling position of the second clip member 163 and to increase the coupling force between the first clip member 161 and the second clip member 163. The second clip member 163 may come into contact with the bus bar 150 at the second clip contact surface 163-1 so as to support the bus bar 150.

The clip 160 may include a protrusion provided on at least one surface of the facing surfaces of the first clip member 161 and the second clip member 163. The protrusion according to an embodiment of the present disclosure may be composed of a plurality of protrusions, which protrude a predetermined height and which are arranged in a matrix pattern.

The second clip member 163 may include a plurality of protrusions provided on the second clip contact surface so as to increase the coupling force between the electrode terminal 133 and the bus bar 150. Since the second clip member 163 includes the plurality of protrusions, it is possible to reduce the effects of manufacturing tolerance and to efficiently support the electrode terminal 133 even when the second clip contact surface 163-1 is uneven due to the manufacturing tolerance.

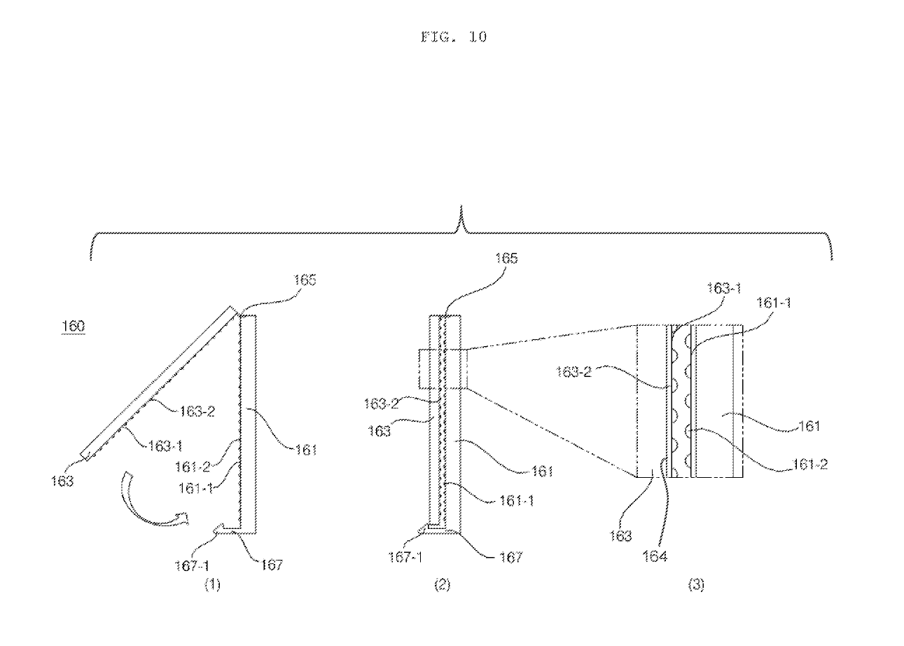

FIG. 10 shows a clip 160 open (1) and closed (2), as well as an expanded view (3). The second clip member 163 may include second clip protrusions 163-2, which are alternately disposed with respect to first clip protrusions 161-2. Since the plurality of second clip protrusions 163-2 provided on the second clip member 163 are alternately disposed with respect to the plurality of first clip protrusions 161-2 provided on the first clip member 161, it is possible to improve the electrical connectivity between the electrode terminal 133 and the bus bar 150. Referring to FIG. 10 at (3), when the first clip member 161 is coupled to the second clip member 163, the plurality of protrusions 163-2 of the second clip member 163 may be positioned between the plurality of protrusions 161-2 of the first clip member 161.

Since the plurality of protrusions 163-2 of the second clip member 163 may be configured to have the same height as height of the plurality of protrusions 161-2 of the first clip member 161, it is possible for the clip 160 to uniformly support the electrode terminal 133 and the bus bar 150.

The plurality of protrusions 161-2 and 163-2 may be configured to have a hemisphere shape so as to stably support the bus bar 150. Although each of the plurality of protrusions 161-1 and 163-2 is configured to have a hemisphere shape in the embodiment, the protrusions may be configured to have any other shape.

The second clip member 163 may include second clip protrusions, which are alternately disposed with respect to the first clip protrusions. A second clip member 163 according to another embodiment of the present disclosure includes a linear groove corresponding to the linear protrusion of the first clip member 161. Accordingly, when the first clip member 161 is coupled to the second clip member 163, at least part of the bus bar 150 may be received in the linear groove, thereby improving the electrical connectivity between the electrode terminal 133 and the bus bar 150.

The linear groove may be composed of a plurality of linear grooves corresponding in number to the number of the plurality of linear protrusions of the first clip member 161. The plurality of linear grooves may be disposed parallel to each other at positions corresponding to respective ones of the plurality of linear protrusions so as to improve the state of contact between the electrode terminal 133 and the bus bar 150.

The clip 160 may include an electrical conductor on at least one of the facing surfaces of the first clip member 161 and the second clip member 163. The protrusions may be disposed on or be a part of the electrical conductor.

The second clip member 163 may include a second clip conductor 164 provided on the second clip contact surface 163-1 so as to improve the electrical connectivity between the electrode terminal 133 and the bus bar 150. The second clip conductor 164 may be made of a material having electrical conductivity higher than that of the clip 160. The second clip conductor 164 may be made of a metal material.

The second clip conductor 164 may be fitted partway into a recess formed in the second clip contact surface 163-1 and may thus be coupled thereto. The second clip conductor 164 may include a protrusion provided on the surface thereof that comes into contact with the bus bar 150. The second clip conductor 164 according to an embodiment of the present disclosure may include a plurality of protrusions provided on the surface thereof that comes into contact with the bus bar 150, which may improve the electrical connectivity between the electrode terminal 133 and the bus bar 150.

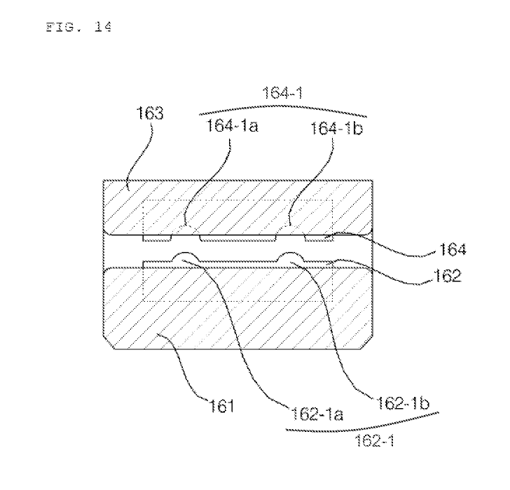

Referring to FIGS. 13 and 14, the second clip conductor 164 according to another embodiment of the present disclosure may include a linear groove 164-1 (including 164-1a, 164-1b, for example), which is provided in the surface thereof that comes into contact with the bus bar 150 and has a shape corresponding to that of the linear protrusion 162-1 (including 162-1a, 162-1b, for example) of the first clip conductor 162, so as to improve the electrical connectivity between the electrode terminal 133 and the bus bar 150. For example, the second clip conductor 164 may include a plurality of parallel linear grooves 164-1 that correspond to respective ones of the plurality of linear protrusions 162-1 so as to efficiently support the bus bar 150.

Although the second clip member 163 according to the embodiment includes the linear groove 164-1 provided in the second clip conductor 164, it is possible to provide a configuration in which the linear groove 164-1 is directly provided in the second clip contact surface 163-1 without providing the second clip conductor 164.

In the embodiment, the first clip member 161 includes the linear protrusion 162-1 while the second clip member 163 includes the linear groove 164-1. Alternatively, the first clip member 161 may include the linear groove and the second clip member 163 may include the linear protrusion.

Referring to FIG. 10, the second clip member 163 may be hingedly connected or mated to one end of the first clip member 161. One end of the first clip member 161 may be connected to one end of the second clip member 163 via a clip hinge 165 such that one of the clip members 161 and 163 is rotatable with respect to the other of the clip members 161 and 163.

Since the second clip member 163 is rotated about the clip hinge 165 and is coupled to the first clip member 161 in a snap-fit manner, it is possible to couple and remove the clip 160. Since the clip 160 is integrally composed of the first clip member 161, the second clip member 163 and the clip hinge 165, it is possible to simplify the manufacturing process.

The clip hinge 165 may have a thickness such that it can be bent and stretched without breaking owing to the elasticity thereof. The length or dimensions of the clip hinge 165 may be set based on the total thickness of the electrode terminal 133 and the bus bar 150, which are disposed between the first clip member 161 and the second clip member 163.

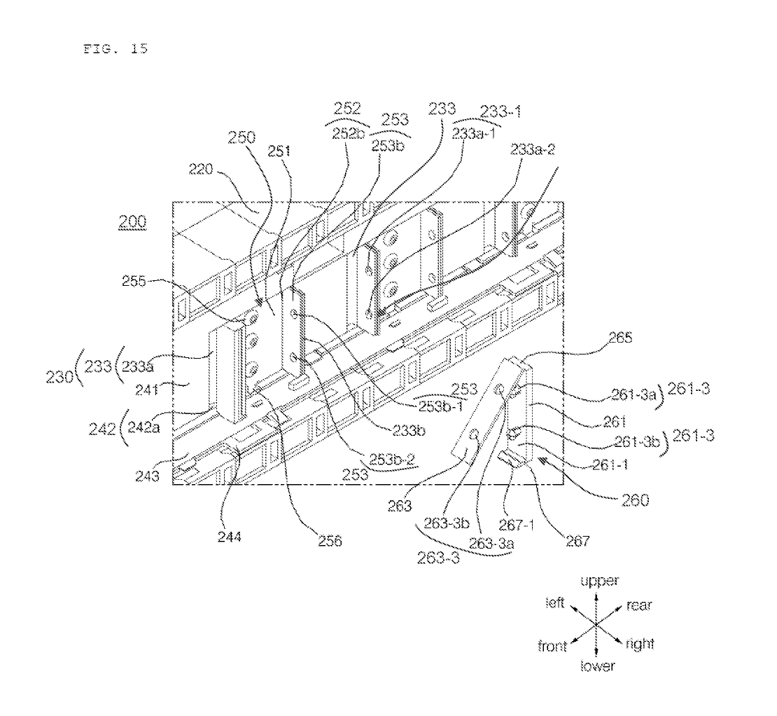

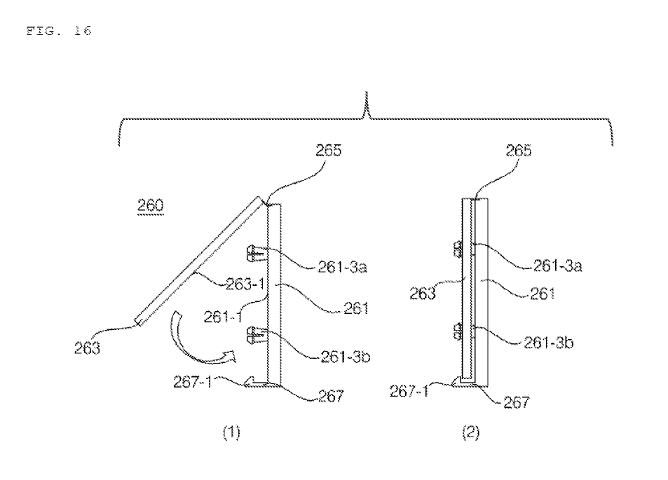

The length or dimensions of the clip hinge 165 may be set such that the second clip member 163 is coupled to the first clip member 161 in a snap-fit manner in the state in which the electrode terminal 133 and the bus bar 150 are disposed between the first clip member 161 and the second clip member 163. A battery module 200 according to another embodiment of the present disclosure will be described with reference to FIGS. 15 and 16 with a focus on structures different from those the first embodiment, and a description of structures identical to those of the first embodiment will be omitted. FIG. 16 shows clip 260 open (1) and the clip 260 closed (2).

An electrode terminal 233 (including 233a, for example) of a battery cell 230 according to the embodiment may include an electrode terminal hole 233-1 (including 233a-1, for example) into which a snap protrusion 261-3 (including 261-3a, 261-3b, for example) is fitted. The electrode terminal hole 233-1 may have a size corresponding to the size of the snap protrusion 261-3.

The electrode terminal hole 233-1 may be configured to have a shape corresponding to that of the snap protrusion 261-3. In the embodiment, the snap protrusion 261-3 is configured to have a circular cross-section and the electrode terminal hole 233-1 is also configured to have a circular cross-section corresponding to the snap protrusion 261-3. However, the snap protrusion 261-3 and the electrode terminal hole 233-1 may have other cross-sectional shapes.

The electrode terminal 233 may be provided with a plurality of electrode terminal holes 233a-1, 233a-2, which are arranged vertically so as to correspond to the plurality of snap protrusions 261-3a, 261-3b, in order to improve the state of contact between the bus bar 250 and the electrode terminal 233. The snap protrusion 261-3 may be fitted into the electrode terminal hole 233-1 so as to couple the bus bar 250 to the electrode terminal 233.

The bus bar 250 according to the embodiment may include a bus bar hole 253 (including 253b-1, 253b-2, for example) into which the snap protrusion 261-3 is fitted. The bus bar hole may be sized so as to correspond to the size of the snap protrusion 261-3. The bus bar 250 may include bus bar body 251.

The bus bar hole 253 may be configured to have a shape corresponding to that of the snap protrusion 261-3. In the embodiment, the snap protrusion 261-3 may be configured to have a circular cross-section and the bus bar hole 253 is also configured to have a circular cross-section so as to correspond to the snap protrusion 261-3. However, the snap protrusion 261-3 and the bus bar hole 253 may have other cross-sectional shapes.

The bus bar 250 may be provided with a plurality of bus bar holes 253, which are arranged vertically so as to correspond to the plurality of snap protrusions 261-3, in order to improve the state of contact between the bus bar 250 and the electrode terminal 233.

The snap protrusion 261-3 may be fitted into the bus bar hole 253 so as to couple the bus bar 250 to the electrode terminal 233. The bus bar 250 may include a plurality of bus bar holes 253 corresponding in number to the plurality of snap protrusions 261-3 so as to increase the coupling force between the clip 260 and the bus bar 250.

The first clip member 261 of the clip 260 according to the embodiment may include the snap protrusion 261-3. The first clip member 261 may include the snap protrusion having a boss shape. The second clip member 263 may be configured to have a shape which is engageable with the snap protrusion 261-3. The first clip member 261 may be coupled to the second clip member 263 in a snap-fit manner.

The first clip member 261 may include at least one snap protrusion 261-3 provided at the center thereof. The at least one boss-shaped snap protrusion 261-3 may be fitted into the snap hole 263-3 (including 263-3a, 263-3b, for example) formed in the second clip member 263, thereby coupling the first clip member 261 to the second clip member 263.

The snap protrusion 261-3 may be provided at the end thereof with a cylindrical snap portion. The snap protrusion 261-3 may have a circular cross-section when viewed in a direction parallel to the first clip contact surface 261-1, and the second clip member 263 may be provided with the snap hole 263-3 having a circular cross-section corresponding to that of the snap protrusion 261-3. Consequently, the embodiment may have a more stable structure than an example having a snap hole having a polygonal cross-section.

The diameter of the snap protrusion 261-3 may be set in proportion to the width of the second clip member 263. Consequently, it may be possible to prevent concentration of stress at the portion of the second clip member 263 that is narrowed owing to the snap hole 263-3, and it may be possible to prevent fatigue failure of the second clip member 263.

The second clip member 263 may be hingedly connected to one end of the first clip member 261. The first clip member 261 and the second clip member 263 may be connected to each other so as to be relatively rotated about the clip hinge 265. When the clip 260 including the snap protrusion 261-3 is coupled to the electrode terminal 233 and the bus bar 250, the clip 260 may come into contact with an adjacent electrode terminal 233 or bus bar 250 or another clip 260, thereby limiting the relative rotation of the clip members 261 and 263.

In order to allow the clip 260 to be coupled to the electrode terminal 233 and the bus bar 250, the height of the snap protrusion 261-3 may be set in consideration of the range that the clip members 261 and 263 are rotatable with respect to each other when the snap protrusion 261-3 is coupled to the electrode terminal 233 and the bus bar 250.

In addition, in order to allow the clip 260 to be coupled to the electrode terminal 233 and the bus bar 250, the position of the snap protrusion 261-3 may be set in consideration of the range that the clip members 261 and 263 are rotatable with respect to each other when the snap protrusion 261-3 is coupled to the electrode terminal 233 and the bus bar 250.

The snap protrusion 261-3 may be provided at the end thereof with a snap portion, which bulges outward and has slits formed therein. Since the slit segments of the snap portion converge upon the application of external force and spread upon release of the external force, it may be possible for the snap protrusion 261-3 to couple the first clip member 261 and the second clip member 263 to each other in a snap-fit manner.

The snap portion that is provided at the end of the snap protrusion 261-3 is oblique at a connecting region at which the snap portion is connected to the cylindrical portion of the snap protrusion 261-3. When the snap protrusion 261-3 is fitted into the snap hole 263-3, the snap hole 263-3 is moved further inward along the sloping surface, resulting in an increase of the coupling force by snap-fit coupling.

The first clip member 261 may include a protrusion provided on the first clip surface 261-1. The protrusion may be composed of a plurality of protrusions, which protrude a predetermined height and which are arranged in a matrix pattern. The first clip member 261 may include a plurality of protrusions, which have a height lower than that of the snap protrusion 261-3, so as to improve the state of contact between the electrode terminal 233 and the bus bar 250.

The protrusion may be embodied as a linear protrusion, which protrudes a predetermined height and extends vertically. Since the first clip member 261 includes the linear protrusion, it is possible to reduce the effects of manufacturing tolerance and to efficiently support the electrode terminal 233 even when the first clip contact surface 261-1 is uneven due to manufacturing tolerance.

Referring to FIG. 15, the second clip member 263 of the clip 260 according to the embodiment may be provided in the center thereof with the snap hole 263-3 so as to be coupled to the first clip member 261 in a snap-fit manner. The second clip member 263 may include at least one snap hole 263-3 into which the snap protrusion 261-3 is fitted such that the first clip member 261 is coupled to the second clip member 263.

The diameter of the snap hole 263-3 may be set in proportion to the width of the second clip member 263. It may be possible to prevent concentration of stress at the portion of the second clip member 263 that is narrowed owing to the snap hole 263-3, and it may be possible to prevent fatigue failure of the second clip member 263.

The length of the snap protrusion 261-3 may be set in consideration of the total thickness of the electrode terminal 233 and the bus bar 250 such that the snap protrusion 261-3 is properly fitted into the electrode terminal 233, the bus bar 250 and the snap hole 263-3 and is properly coupled thereto. The snap protrusion 261-3 may be coupled to the snap hole 263-3 by using, for example, heat fusion, and the electrode terminal 233 and the bus bar 250 may be electrically connected to each other. The coupled state of the clip 260 due to the heat fusion may be released by the application of heat.

The second clip member 263 may be hingedly connected to one end of the first clip member 261. Although the clip 260 according to the embodiment is configured such that the first clip member 261 and the second clip member 263 are hingedly connected to each other by using, for example, the clip hinge 265, it is alternatively possible to provide another configuration in which the first clip member 261 and the second clip member 263 are coupled to each other in a snap-fit manner by using, for example, a separate member.

With reference to FIG. 15, the battery module 200 includes similar structure to the embodiment of FIG. 5 including cell cartridge 220, circuit board body 241, sub circuit board 243, circuit board coupling portion 244, bus bar body 251, bus bar coupler 255, and bus bar terminal 256.

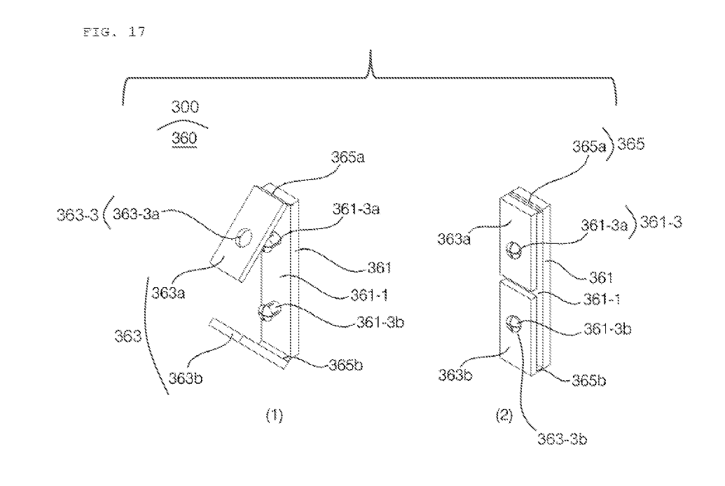

A battery module 300 according to a further embodiment of the present disclosure will be described with reference to FIG. 17 with a focus on structures different from those of the battery module 100 according to the first embodiment, and a description of structures identical or similar to those of the battery module 100 of the first embodiment may be omitted. FIG. 17 shows clip 360 open (1) and the clip 360 closed (2).

The clip 360 according to the embodiment may include a first clip member 361 and a plurality of second clip members 363 (including 363a, 363b, for example), each of which is hingedly connected at one end thereof to the first clip member 361 and each of which is coupled at the other end thereof to the first clip member 361. The first clip member 361 may be connected or mated at opposite ends thereof to the plurality of second clip members 361 by using, for example, clip hinges 365 (including 365a, 365b for example).

In the clip 360 according to the embodiment, the first clip member 361 is provided with a plurality of boss-shaped snap protrusions 361-3 (361-3a, 361-3b), which are respectively fitted into snap holes 363-3 (including 363-3a for example) formed in the plurality of second clip members 363, with the result that the first clip member 361 is able to be coupled to the plurality of second clip members 363.

The first clip member 361 may be provided on a first clip contact surface 361-1 with a protrusion so as to improve the state of contact between the electrode terminal 133 and the bus bar 150. The protrusion may be composed of a plurality of protrusions, which are arranged in a matrix pattern. The protrusion may be embodied as a linear protrusion, which extends in the longitudinal direction of the clip 360.

Referring to FIG. 17, the second clip member 363 may include a second upper clip member 363a having a snap hole 363-3b therein and a second lower clip member 363b having a snap hole 363-3b therein such that the first clip member 361 is coupled to the plurality of second clip members 363a and 363b.

When the clip 360 including the snap protrusion 361-3 is coupled to the electrode terminal 133 and the bus bar 150, the clip 360 may come into contact with an adjacent electrode terminal 133 or bus bar 150 or another clip 360, thereby limiting the relative rotation of the clip members 361 and 363.

In order to allow the clip 360 to be coupled to the electrode terminal 133 and the bus bar 150, the height of the snap protrusion 361-3 may be set in consideration of the range that the clip members 361 and 363 are rotatable with respect to each other when the snap protrusion 361-3 is coupled to the electrode terminal 133 and the bus bar 150.

Since the distance that each of the second clip members 363 protrudes outward when the second clip member 363 is rotated is shorter than the previous embodiment, in which the second clip member 363 is composed of a single second clip member, it is advantageous compared to an embodiment which includes a single second clip member when the second clip member 363 is coupled to the electrode terminal 133 and the bus bar 150.

In the embodiment, each of the plurality of second clip members 363 is coupled to the first clip member 361. Alternatively, the second upper clip member 363a and the second lower clip member 363b may be connected to each other.

The second upper clip member 363a may include a snap hook provided at one end thereof and the second lower clip member 363b may include a snap hook at one end thereof that is coupled to the second upper clip member 363a such that the plurality of second clip members 363 are coupled to each other in a snap-fit manner.

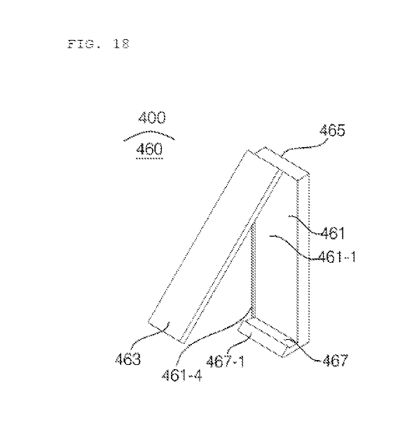

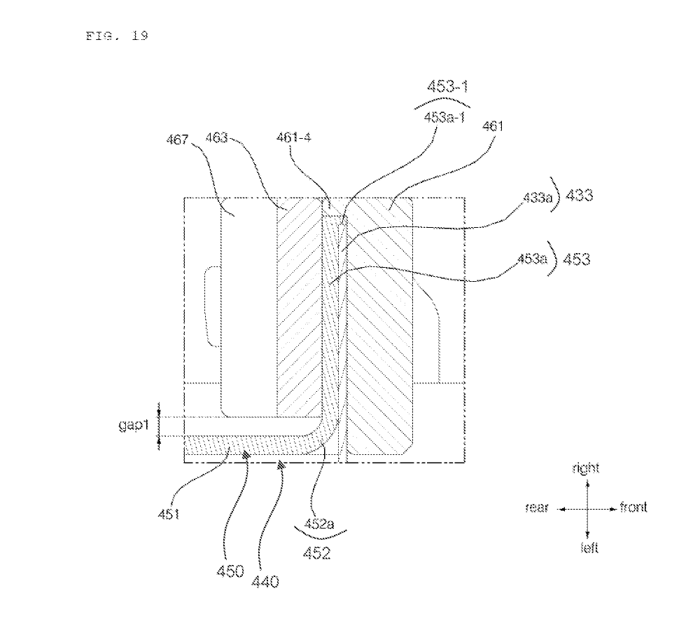

A battery module 400 according to yet a further embodiment of the present disclosure will be described with reference to FIGS. 18 to 19 with a focus on structures different from those of the battery module 100 according to the first embodiment, and a description of structures identical or similar to those of the battery module 100 of the first embodiment may be omitted.

A bus bar leg 453 (including 453a for example) of a bus bar 450 according to the embodiment may be bent at one end thereof and may extend toward the electrode terminal 433 (including 433a for example) so as to guide the contact position of the electrode terminal 433 and the bus bar 450. The distal end of the bus bar leg 453 that is positioned far from the body of the bus bar 450 may be bent at a predetermined angle toward the electrode terminal 433.

A bent portion 453-1 (including 453a-1 for example) provided at an end of the bus bar leg 453 may be configured to come into contact with the distal end of the electrode terminal 433 extending from a battery cell (not shown in FIG. 19) so as to guide the contact position of the bus bar 450 and the electrode terminal 433 upon contact there between. The distal end of the bus bar leg 453 may be bent so as to protect the electrode terminal-bus bar contact surfaces from contamination.

The clip 460 according to the embodiment may be embodied such that the one of the first clip member 461 and the second clip member 463 that contacts the electrode terminal 433 may extend further toward the battery cell 430 than the other of the first clip member 461 and the second clip member 463 that contacts the bus bar 450 so as to improve the state of contact between the bus bar 450 and the electrode terminal 433 and the clip 460 and to protect the bus bar 450 and the electrode terminal 433 from shocks and contamination.

The first clip member 461 may be configured to have a length such that the first clip member 461 extends toward the circuit board 140 further than the second clip member 463. Since the contact area between the first clip contact surface 461-1 and the electrode terminal 433 is increased, it may be possible to protect the electrode terminal 433 from shocks and contamination.

In the embodiment, the first clip member 461 contacts the electrode terminal 433 while the second clip member 463 contacts the bus bar 450. Alternatively, when the first clip member 461 contacts the bus bar 450 while the second clip member 463 contacts the electrode terminal 433, the second clip member 463 may extend forward from the circuit board 440 further than the first clip member 461.

The clip 460 may include a wall or ridge provided at a peripheral region thereof that is positioned far from the battery cell 130, the wall extending in a longitudinal direction of a contact portion or contact area between the electrode terminal 433 and the bus bar 450 (and the wall extending in a perpendicular direction to the electrode terminal) so as to surround the peripheral region. Accordingly, it is possible to protect the electrode terminal 433 and the bus bar 450 from shocks and contamination.

Referring to FIG. 18, the first clip member 461 may include a clip wall 461-4, which is provided on the first clip contact surface 461-1 and extends vertically. In other words, the first clip member 461 may include the clip wall 461-4 at one side of a peripheral region of the first clip contact surface 461-1 in the transverse direction of the first clip contact surface 461-1. The first clip member 461 may include the clip wall 461-4, which is adjacent at one end thereof to the clip hinge 465 and at the other end thereof to the snap protrusion 467. The snap protrusion 467 may include the snap hook 467-1

Referring to FIG. 19, when the clip 460 is coupled to the electrode terminal 433 and the bus bar 450, the coupling position may be guided by the clip wall 461-4 provided on the first clip contact surface 461-1. In the embodiment, the clip wall 461-4 is provided on the first clip contact surface 461-1 of the first clip member 461. Alternatively, the clip wall 461-4 may be provided on the second clip member 463 or on both the first clip member 461 and the second clip member 463.

In the embodiment, the second clip member 463 is configured to cover the clip wall 461-4. Alternatively, the second clip member 463 may be configured to cover the remaining region of the first clip contact surface 461-1 excluding the region corresponding to the clip wall 461-4. The height of the clip wall 461-4 from the first clip contact surface 461-1 may be set so as to cover one surface of the second clip member 463 when the first clip member 461 is coupled to the second clip member 463.

Referring to FIG. 19, the second clip member 463 may be disposed to be spaced apart from the bus bar bent portion 452 (including 452a for example) of the bus bar 450 in order to prevent the first clip member 461 from being spaced apart from the bus bar leg 453 due to the curvature of the bus bar bent portion 452 and thus to prevent the occurrence of a loose connection there between.

Since the second clip member 463 is disposed to be spaced apart from the bus bar body 451 by a distance gap1, it is possible to prevent the occurrence of a loose connection between the first clip member 461 and the bus bar 450 due to the curvature of the bus bar bent portion 452. The distance gap1 may be set depending on the curvature of the bus bar bent portion 152.

Since the second clip member 463 is disposed to be spaced apart from the body of the bus bar 450 by a distance gap1 and the first clip member 461 extends toward the circuit board 440 further than the second clip member 463, it is possible to improve the state of contact between the clip 460 and the bus bar 450 and to protect the electrode terminal 433 and/or the bus bar 450 from foreign substances.

In the embodiment, the first clip member 461 contacts the electrode terminal 433 and the second clip member 463 contacts the bus bar 450. Alternatively, when the first clip member 461 contacts the bus bar 450 and the second clip member 463 contacts the electrode terminal 433, the second clip member 463 may extend toward the circuit board further the first clip member 461.

Since the battery module according to the present disclosure includes the cover clip including a first clip member and a second clip member, which are coupled to each other to bring the electrode terminal into contact with the bus bar, there may be an advantage of enabling the plurality of battery cells to be detachably coupled thereto.

Since the first clip member is provided with the snap hook and the second clip member is configured to be coupled to the snap hook, the first clip member can be coupled to the second clip member in a snap-fit manner. Since the second clip member is hingedly coupled to one end of the first clip member, there may be an advantage of being able to detachably couple the first clip member to the second clip member. Accordingly, when one of the plurality of battery cells constituting the battery module develops a problem, the clip is separated from the electrode terminal and the bus bar, thereby allowing the problematic battery cell to be removed from the battery module.

The battery module according to the present disclosure, in which the first clip member and the second clip member are coupled thereto so as to electrically connect the plurality of electrode terminals to each other, confers advantages in that there is no problem of deterioration of weld quality due to wear of welding tools over time, which afflicts a conventional process of manufacturing a battery module, and in that it is possible to uniformly couple the electrode terminal to the bus bar.

The battery module according to the present disclosure, in which the clip, the electrode terminals and the bus bar are mechanically coupled to each other, confers an advantage in that there is no concern about damage to the battery cell attributable to the generation of high-temperature heat, unlike a conventional welding process.

Since the clip according to the present disclosure is configured to surround opposite side peripheral regions of the contact portion or contact area between the electrode terminal and the bus bar in the longitudinal direction of the contact portion and to be spaced apart from the bent portion of the bus bar, there is an advantage of being able to improve the electrical connectivity between the electrode terminal and the bus bar.

In addition, since the clip includes the wall, which is provided at a peripheral region of the clip that is positioned far from the battery cell, the wall extending in the longitudinal direction of the contact portion or contact area between the electrode terminal and the bus bar so as to surround the peripheral region, there is an advantage of being able to protect the electrode terminal and the bus bar from external shocks and foreign substances.

Furthermore, since the clip includes protrusions provided on the first clip member and the second clip member, and since the protrusions on the first clip member and the protrusions on the second clip member are alternately arranged with each other, there is an advantage of being able to improve the electrical connectivity between the electrode terminal and the bus bar.

The present disclosure provides a battery module in which battery cells are individually coupled to the battery module in a detachable manner. Further, a problem in which welding quality is deteriorated due to wear of welding tools over time in a process of manufacturing a battery module may be solved.

A problem in which a battery cell is damaged due to heat generated during welding of a battery module may be solved based on the present disclosure. The electrical connectivity of a battery cell may be improved based on the present disclosure.

In accordance with an aspect of the present disclosure, the above and other objects can be accomplished by the provision of a battery module including a plurality of battery cells stacked on one another, each of which includes an electrode terminal protruding at least in one direction, a bus bar, which is bent so as to form a bus bar contact surface parallel to the electrode terminal and which electrically connects adjacent electrode terminals of battery cells to each other, and a clip including a first member and a second member, which are coupled to each other so as to bring the electrode terminal and the bus bar into contact with each other.

The first member of the clip may include a snap protrusion and the second member of the clip may be configured to be engaged with the snap protrusion such that the first member and the second member are coupled to each other in a snap-fit manner.

The second member of the clip may be hingedly connected to one end of the first member of the clip.

The clip may surround opposite side peripheral regions of the contact portion or contact area between the electrode terminal and the bus bar in the longitudinal direction of the contact portion and may be spaced apart from a bent portion of the bus bar.

The clip may include a wall, which is provided at a peripheral region of the clip that is positioned far from the battery cell, the wall extending in the longitudinal direction of the contact portion between the electrode terminal and the bus bar so as to surround the peripheral region.

The clip may include protrusions provided at the first member and protrusions provided at the second member and alternately arranged with the protrusions of the first member.

The disclosure provides a battery module comprising at least one cell including an electrode terminal protruding along a prescribed direction, at least one bus bar having a bus bar contact surface, and at least one clip having a first member and a second member, the at least one clip clamping the electrode terminal with the bus bar contact surface when the first and second members are mated to prevent separation of contact between the electrode terminal and the bus bar contact surface.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present disclosure.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein should be interpreted accordingly.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A battery module comprising:
at least one cell including an electrode terminal protruding along a prescribed direction;
at least one bus bar having a bus bar contact surface; and
at least one clip having a first member and a second member, the at least one clip clamping the electrode terminal with the bus bar contact surface when the first and second members are mated to prevent separation of contact between the electrode terminal and the bus bar contact surface.

2. The battery module according to claim 1, wherein the first member includes a snap protrusion, and the second member is engageable with the snap protrusion such that the first member and the second member are mated to each other in a snap-fit manner.

3. The battery module according to claim 2, wherein the first member includes a first member end and the second member includes a second member end, and the second member end is hingedly connected, so as to be mated, to the first member end.

4. The battery module according to claim 2, wherein the second member includes a snap hole formed in a middle thereof through which the snap protrusion passes.

5. The battery module according to claim 4, wherein the electrode terminal includes an electrode terminal hole through which the snap protrusion passes, and
wherein the at least one bus bar includes a bus bar hole through which the snap protrusion passes.

6. The battery module according to claim 4, wherein the snap protrusion and the snap hole are coupled to each other by heat fusion.

7. The battery module according to claim 1, wherein the second member comprises a third member and a fourth member,
wherein one end of the third member is hingedly connected to one end of the first member,
wherein one end of the fourth member is hingedly connected to the other end of the first member and the other end of the fourth member is mated, to be adjacent to the other end of the third member, in a snap-fit manner.

8. The battery module according to claim 1, wherein the at least one bus bar includes a bent portion, and
the at least one clip covers peripheral regions of the bus bar contact surface, and the at least one clip being spaced apart from the bent portion of the at least one bus bar.

9. The battery module according to claim 8, wherein a width of the first member and a width of the second member in the prescribed direction is different from each other.

10. The battery module according to claim 8, wherein the at least one clip includes a ridge, which is provided at a peripheral region of the at least one clip, and the ridge extends in a second direction that is perpendicular to the prescribed direction so as to cover a first side of the bus bar located further from the at least one cell.

11. The battery module according to claim 1, wherein the at least one bus bar includes a bus bar leg that includes a bent portion and one end beyond the bent portion extends toward the electrode terminal.

12. The battery module according to claim 1, wherein the at least one clip includes:
a first facing surface, on the first member, that faces the second member; and
a second facing surface, on the second member, that faces the first member; and
at least one protrusion provided on at least one of the first or second facing surfaces.

13. The battery module according to claim 12, wherein the at least one protrusion includes a plurality of protrusions, which protrude at a predetermined height and are arranged in a matrix pattern.

14. The battery module according to claim 13, wherein the plurality of protrusions includes first protrusions provided on the first member and second protrusions provided on the second member, and the second protrusions are alternately arranged with the first protrusions.

15. The battery module according to claim 12, wherein the at least one protrusion includes at least one linear protrusion, which extends in a direction perpendicular to the prescribed direction.

16. The battery module according to claim 15, wherein the first member includes the at least one linear protrusion and the second member includes at least one linear groove having shape corresponding to the at least one linear protrusion.

17. The battery module according to claim 12, wherein the at least one clip includes an electrical conductor provided on at least one of the first or second facing surfaces, and the at least one protrusion is provided on the electrical conductor.

18. The battery module according to claim 1, wherein the at least one clip includes a cushion provided on at least one of facing surfaces of the first and second members.

19. A vehicle comprising the battery module according to claim 1.
